(19) United States
(12) Patent Application Publication
(10) Pub. No.: US 2016/0362093 A1
(43) Pub. Date: Dec. 15, 2016

(54) AIRCRAFT WHEEL BRAKING PERFORMANCE COMMUNICATIONS SYSTEMS AND METHODS

(71) Applicant: Engineered Arresting Systems Corporation, Aston, PA (US)

(72) Inventor: John Gadzinski, Virginia Beach, VA (US)

(21) Appl. No.: 15/179,359

(22) Filed: Jun. 10, 2016

Related U.S. Application Data
(60) Provisional application No. 62/174,290, filed on Jun. 11, 2015.

(51) Int. Cl. B60T 8/17; B64F 5/00; B64C 25/42

(52) U.S. Cl. CPC B60T 8/1703; B64C 25/42; B64F 5/0045

(57) ABSTRACT

Systems and methods for providing aircraft braking signal alerts for aircraft are described including a first braking condition signal generated by a first aircraft or a control station. The first braking condition signal may include, for example, a timestamp, an airfield identifier, a runway identifier, and/or first braking condition information. A runway to be used by a second aircraft may be determined automatically, and a determination made regarding the relevance of the first braking condition information to the second aircraft. A braking alert signal for the second aircraft may be generated and/or updated based on the first braking condition information, and a visual indicator may be presented to an operator of the second aircraft based on the braking alert signal. The first braking condition information may be overwritten based on a second braking condition signal received from a third aircraft or the control station.

### CROSS REFERENCE TO RELATED APPLICATIONS

This application claims the benefit of U.S. Provisional Application Ser. No. 62/174,290, filed Jun. 11, 2015, titled “Aircraft Wheel Braking Performance Communications Methods,” the entire contents of which are hereby incorporated by reference.

### FIELD OF THE INVENTION

The present disclosure relates to systems and methods for automatically sharing braking performance information among vehicles, vehicle operators, and/or airport operators, and more particularly, but not necessarily exclusively, to mechanisms and techniques for supplying human pilots and/or airport operators with up to date, and in some cases near real-time, information designed to assist pilots and/or airports related personnel in assessing and/or dealing with degradation of ground deceleration performance for a given runway.

### BACKGROUND

Aircraft wheel brake systems are recognized in the industry as varying their performance effectiveness as a function of the actions of the associated anti-skid system. To the degree the anti-skid system must function to release the wheel brakes and allow the tire to roll freely without mechanical resistance, the effectiveness of the braking system is directly reduced. When this action occurs at such a level as to correspond to certain identifiably contaminated conditions that are deemed to create a risk for the operator, it has been necessary to transmit this information from one aircraft to another so that proper assessments, decisions, and crew procedures can be made.

It is normal to those familiar with creating aircraft performance figures and to those who operate aircraft to classify the expected level of wheel brake performance for a given runway into categories. These categories can include numerical codes or definitive words such as “Good,” Medium” or “Poor.” In 2015 and 2016 the Federal Aviation Administration (FAA) codified a series of classifications that correlate levels of aircraft braking performance and runway contaminant descriptions in a series of advisory circular publications, an example of which can be found in FIG. 1. These publications represent an international effort to classify ranges of performance that all aircraft use when making an assessment of a landing ground roll. An analysis of major commercial accidents in the last 30 years has definitively shown that actual aircraft wheel braking performance levels that occur at a lower value than anticipated by the flight crew can create conditions for unsafe acts whereby normal safety margins can be easily exceeded resulting in runway excursions.

While this normally occurs at braking levels categorized by the FAA as less than medium or code 3 in the Runway Condition Assessment Matrix (RCAM) as shown in FIG. 1, unexpected braking performance that results in less capabilities than the flight crew has assessed for the landing or takeoff can pose a hazard at any level outlined by the FAA's guidance.

Unfortunately, one of the risks associated with the guidance published by the FAA and the guidance being considered by ICAO is that conditions can change unexpectedly for a variety of reasons. Active precipitation can invalidate the observations made by an airport or a braking action report made by a flight crew. It is normal and customary for those skilled in the art of operating commercial aircraft for information relating to braking performance to arrive following a certain pathway. This pathway normally involves a manual process of information input by airport and or air traffic control personnel who use radio transmissions and or data link messages. However, normal aircraft travel at speeds ranging between 250 to 170 nautical miles per hour when flight crews are tasked with making decisions and assessments regarding future braking performance. During this time, cognitive tasking must be shared between radio communications, navigation, aircraft configuration, and other piloting skills. It is normal for errors to occur in this environment when information lags behind the opportunities that occur for relevant action to be taken. In this case, the pathway of information from one aircraft observing a changing condition to another aircraft who has a need to observe that information must pass through an information bottleneck in place in the existing pathway.

The result is a process where the flow of information from one aircraft to another is too slow to enable a process known as an “OODA Loop.” This is a process whereby information is available for a person to “observe,” enabling them to then “orient” themselves to a potentially changing situation where a “decision” can be made followed by an “assessment” to the effectiveness of that action. The process is then repeated continually and the speed with which the new observations can be made defines a basic quality of the endeavor.

Events that occur at a rate too quickly for effective observation effectively blind a person to changing conditions and are said to occur outside of the decision loop. Mitigations to hazards such as these commonly focus on increasing the speed in which information flows to an observer so as to enable a higher sampling rate and a quicker speed for the “OODA Loop” to take place.

In light of this, the commercial transport aircraft industry has a need for an effective manner to transmit important braking related information from one aircraft to another and to integrate this information into the human decision making process normally associated with flight crew practices, conventions, and procedures. This need must also be balanced against the needs of the industry to ensure commercially viable operations without unnecessary interference arising from incomplete, inaccurate, or untimely information.

Related systems, such as the Braking Action Safety System (BASS), are described in U.S. Pat. No. 8,738,201 and U.S. Pat. No. 8,224,507 to Edwards et al., and U.S. Pat. No. 9,278,674 to Gadzinski, the contents of which are all incorporated herein by reference. For the purposes of this description, a BASS signal may be understood as referring to an aircraft generated signal signifying a degraded wheel brake performance such that the aircraft's performance can be classified according to standard runway conditions assessment matrix (RCAM) methods such as “Good,” “Medium,” “Poor,” RCAM runway condition codes ranging from 5 to 0 as appropriate, or any description of runway related aircraft performance listed in a standard ICAO, FAA or other state publication.

### BRIEF SUMMARY

Embodiments of the invention described herein provide systems and methods for automatically sharing braking performance information among vehicles, vehicle operators, and/or airport operators.

According to first aspects of the invention, aircraft braking condition communications and braking condition signal alert systems for use in an aircraft may be provided. Such systems may include one or more receivers configured to receive a first braking condition signal from at least one of another aircraft or a control station. The first braking condition signal may include first braking condition information for a specified runway. The system may further include a braking subsystem configured to monitor braking conditions of the aircraft and to generate second braking condition information based on a comparison of the braking conditions and a predetermined threshold. A processor may be configured to analyze the first braking condition information to generate a braking alert signal based on at least one of the first braking condition information, and to generate a second braking condition signal based at least in part on the second braking condition information. A processor may also be configured to overwrite the first braking condition information based on a third braking condition signal received from at least one of another aircraft or the control station. An alert display may be configured to receive the braking alert signal, and to present a visual indicator to an operator of the aircraft based on the braking alert signal. In some embodiments, the processor may be configured to activate a first alert display based on the first braking condition information, and to activate a second alert display (that is different than the first alert display) based on the second braking condition information.

In embodiments, a transmitter may be configured to transmit the second braking condition signal to at least one of another aircraft and/or the control station.

In embodiments, the first braking condition signal may include a runway identifier, and the processor may be further configured to generate the braking alert signal based at least in part on the runway identifier.

In embodiments, a navigation subsystem may be configured to identify an intended runway to be used for at least one of takeoff or landing. The first braking condition signal may include a runway identifier, and the processor may be further configured to generate the braking alert signal based at least in part on a determination that the runway identifier corresponds to the intended runway to be used by the aircraft for at least one takeoff and/or landing.

In embodiments, the first braking condition signal may be received from an aircraft, and the third braking condition signal may be received from a control station; the first braking condition signal may be received from an aircraft, and the third braking condition signal may be received from another aircraft; and/or the first braking condition signal may be received from a control station, and the third braking condition signal may be received from an aircraft.

In embodiments, the predetermined thresholds may be associated with standardized runway-related aircraft performance codes included in a regulatory publication.

In embodiments, the braking condition signals may share a common format including, for example, a timestamp, an airfield identifier, a runway identifier, and a braking condition identifier.

In embodiments, the braking condition signals may include, or be based on, a combination of airport operator runway assessment information and aircraft braking condition information.

According to further aspects of the invention, systems for providing aircraft braking condition communication and braking condition signal alerts may be provided. Such systems may include one or more receivers configured to receive a first braking condition signal from a first aircraft. The first braking condition signal may include first braking condition information for a specified runway. A processor may be configured to analyze the first braking condition information, and to generate a separate braking condition signal based at least in part on the first braking condition information. A transmitter may be configured to send the separate braking condition signal to a second aircraft. The processor may be further configured to overwrite the first braking condition information based on at least one of a second braking condition signal received from another aircraft for the specified runway, or a runway condition update for the specified runway. The transmitter may be further configured to send an updated braking condition signal to the second aircraft based at least in part on the processor overwriting the first braking condition information.

In embodiments, the processor may be further configured to generate a braking alert signal based on the first braking condition information, and to cause display of a visual indicator based on the braking alert signal. The visual indicator may be presented, for example, to an airport operator that is intending the specified runway to be used for at least one of takeoff or landing.

In embodiments, the first braking condition signal may include a runway identifier, and the processor may be further configured to generate the braking condition signal for other aircraft that are intending to use the specified runway for at least one of takeoff or landing.

In embodiments, the predetermined thresholds associated with the braking conditions signals may be associated with standardized runway-related aircraft performance codes included in a regulatory publication.

In embodiments, the braking condition signals may share a common format including, for example, a timestamp, an airfield identifier, a runway identifier, and/or a braking condition identifier.

In embodiments, the updated braking condition signal may be sent in preparation to, or during, at least one of takeoff or landing of the second aircraft.

According to further aspects of the invention, methods for providing aircraft braking signal alerts for aircraft may be provided. Such methods may include receiving a first braking condition signal from at least one of a first aircraft or a control station. The first braking condition signal may include, for example, a timestamp, an airfield identifier, a runway identifier, and/or first braking condition information. A runway to be used by a second aircraft for takeoff or landing may be determined automatically (e.g., by various methodologies described further herein). The first braking condition signal may be analyzed, and a determination made regarding the relevance of the first braking condition information to the second aircraft based on the airfield identifier, the runway identifier and the runway to be used by the second aircraft. A braking alert signal for the second aircraft may be generated and/or updated based at least in part on the first braking condition information. A visual indicator may be presented to an operator of the second aircraft based at least in part on the braking alert signal. The first braking condition information may be overwritten based on another braking condition signal received from at least one of a third aircraft or the control station.

Embodiments may also include monitoring braking conditions of the second aircraft during takeoff or landing, and generating a third braking condition signal for the runway via the second aircraft based on a comparison of the braking conditions and predetermined thresholds.

In embodiments, the predetermined thresholds may be associated with standardized runway-related aircraft performance codes included in a regulatory publication.

In embodiments, the first braking condition signal may be received from an aircraft, and the second braking condition signal may be received from a control station; the first braking condition signal may be received from an aircraft, and the second braking condition signal may be received from another aircraft; and/or the first braking condition signal may be received from a control station, and the second braking condition signal may be received from an aircraft.

In embodiments, the braking condition signals may include, or be based on, a combination of airport operator runway assessment information and aircraft braking condition information.

In embodiments, determining the runway to be used by the second aircraft may include analyzing navigation information from at least two different operators of the second aircraft.

In embodiments, determining the runway used by the first aircraft may include analyzing navigation information from at least two different operators of the first aircraft.

According to aspects of the invention, various operational hazards may be addressed and/or mitigated beyond solutions provided by currently available techniques. For example, in many scenarios, there is insufficient time for the conventional process of communicating to provide direction to the flight crew of a landing airplane when an airplane that has just previously landed experiences poor braking. Aspects of the present disclosure may provide methods for automatically communicating this information in real-time.

Using conventional systems, there is also no ability for two separate aircraft to automatically know that they are both operating or intending to operate on the same runway at the same airport. There is also need for a system to recognize the intent of the two people operating an aircraft with respect to the intentions to operate on a particular runway. Aspects of the present disclosure may provide methods for this type of discrimination to automatically take place.

According to aspects of the disclosure, a flight crew may be provided with an alert, warning, caution, or annunciation that another aircraft has experienced a level of braking performance on the same runway they are intending to operate on to the extent that an immediate awareness of that condition needs to be known by the flight crew.

According to aspects of the disclosure, a standard automated method of communication regarding aircraft braking performance may also be provided, and may allow airports, airlines, and other stakeholders to have visibility in to the same information.

Using conventional systems, when an airplane lands and powers down its electronics, it would not be able to transmit braking information to other airplanes. According to aspects of the disclosure, methods for receiving braking information from the operating airplane, and repeating it for other airplanes who intend to operate on the same runway at later times, may be provided.

According to further aspects of the disclosure, methods for airports to communicate that mitigations to a runway condition have been accomplished since the last reported aircraft report may also be provided, whereby aircraft receiving an updated signal can adjust to the new conditions accordingly, such as canceling and/or modifying an active braking alert.

According to further aspects of the disclosure, aircraft may be allowed to report braking performance to each other without going through a ground-based airport repeater. This may be advantageous, for example, because of time constraints, equipment failures where this capability acts as a redundant backup capability, or in cases where the airport does not possess a processing unit.

In embodiments, disclosed systems and methods may allow, for example, an airport operator to visually integrate the specific and unique braking condition signals being transmitted from aircraft, to relate them to the specific runways being referred to, and to interface in such a manner as to modify the braking condition signal once mitigations to the runway condition have occurred.

Embodiments may also include processing units (e.g. one or more microprocessors) configured to prioritize and discriminate between conflicting braking condition signals and the like. Such methodologies may be based, for example, on timestamp information, control station or other precedence, runway identification, etc.

Some or all of the processes described herein, or variations and/or combinations thereof, may be performed under the control of one or more computer systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention claimed. The detailed description and the specific examples, however, indicate only preferred embodiments of the invention. Various changes and modifications within the spirit and scope of the invention will become apparent to those skilled in the art from this detailed description.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and various ways in which it may be practiced. In the drawings:

FIG. 1 shows a related art Operational Runway Condition Assessment Matrix and serve as an example for predetermined thresholds that may be associated with standardized runway-related aircraft performance codes included in regulatory publications.

FIG. 2 shows a flight control and navigation display according to aspects of the invention.

FIG. 3 shows a flight control suite and associated displays according to aspects of the invention.

FIG. 4 shows exemplary runway indicators according to aspects of the invention.

FIG. 5 shows exemplary braking condition signal and braking alert signal navigation arming logic according to aspects of the invention

FIG. 6 shows exemplary braking condition signal and braking alert signal processing and transmission logic according to aspects of the invention

FIG. 7 shows various data gathering, processing and communication paths according to aspects of the invention

FIG. 8 shows exemplary details of a braking condition signal according to aspects of the invention

FIGS. 9 and 10 show exemplary aircraft processor logic routines according to aspects of the invention.

FIG. 11 shows an exemplary control station interface according to aspects of the invention

FIG. 12 shows exemplary braking condition information sourcing, logic and display according to aspects of the invention

### DETAILED DESCRIPTION

Unless defined otherwise, all technical terms used herein have the same meanings as commonly understood by one of ordinary skill in the art to which the invention pertains. The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals reference similar parts throughout the several views of the drawings.

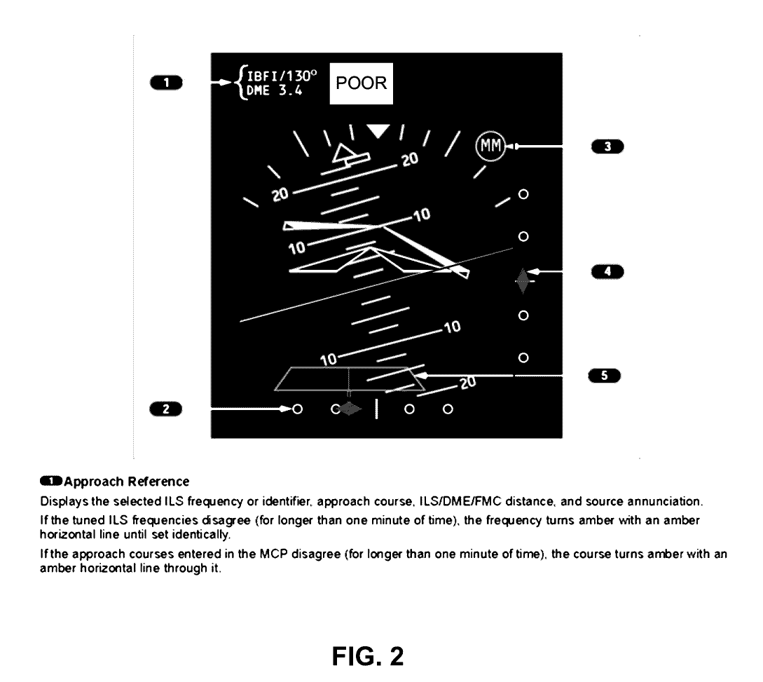

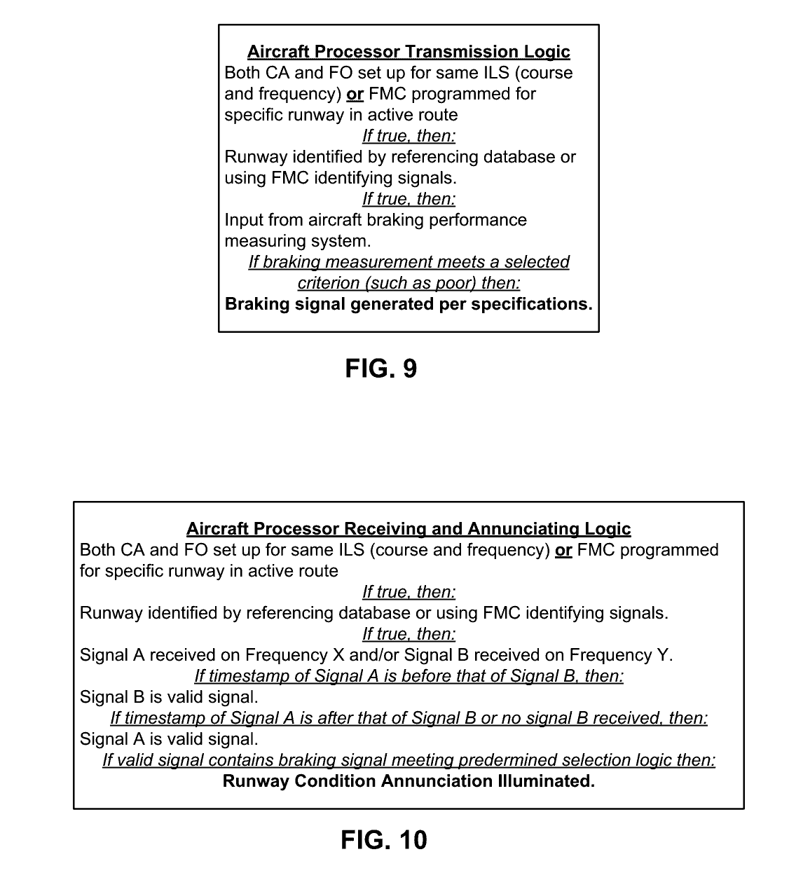

FIG. 2 shows what is known as a primary flight display (PFD) that combines the auto-tuning and comparator functions of a B737NG with the aircraft to aircraft communications function of Runway Condition Annunciator using a processing logic, such as that described later in the description and shown in FIG. 9. The purpose of such a device would be to allow the operator on an aircraft that has an intent to operate on a specific runway the ability to receive real-time (or near real-time) Braking Signal notifications originating from other aircraft operating on that same runway, and at the same time allow for protection against conditions which would render such a notification operationally invalid.

Item (1) noted in FIG. 2 shows a function that employs a method of identifying a ground based radio frequency and comparing it to a magnetic navigation course that has been set by the flight crew. When both the captain and first officer have the same radio frequency tuned and the same navigation course selected, the display is modified to reflect that arrangement. When the electronic approach frequency coded identifier for a particular airport runway's approach has also been recognized, a computer further modifies the display to show the coded information, normally displayed as a series of letters next to the selected navigation course. This coded information is the same as displayed to the flight crew on the charted navigational reference material used to brief and fly an approach to a particular runway at an airport.

As also shown in FIG. 2, a visual indicator reflecting a braking condition (in this case “POOR”) related to a specific runway may be displayed in proximity to the navigation information in Item (1).

In embodiments, additional methodologies may be added, e.g. by also referencing a space based (GPS or equivalent) navigation method of navigation that is normally displayed and controlled on navigation computer normally referred to as a Flight Management Computer (FMC) in the cockpit. Since this type of navigation does not depend on a crew manipulated magnetic course selector nor a coded ground based radio transmitter, this information is presented as a function of FMC programming, a function that would be recognized to those skilled in the art of flying FMC equipped aircraft.

An additional feature of the invention allows for the FMC to be programmed through the selection of a runway without any associated instrument approach being selected. This feature of FMC operations may allow an intended runway to be used for navigation to visual approaches where no instrument procedure either exists or is desired by the flight crew.

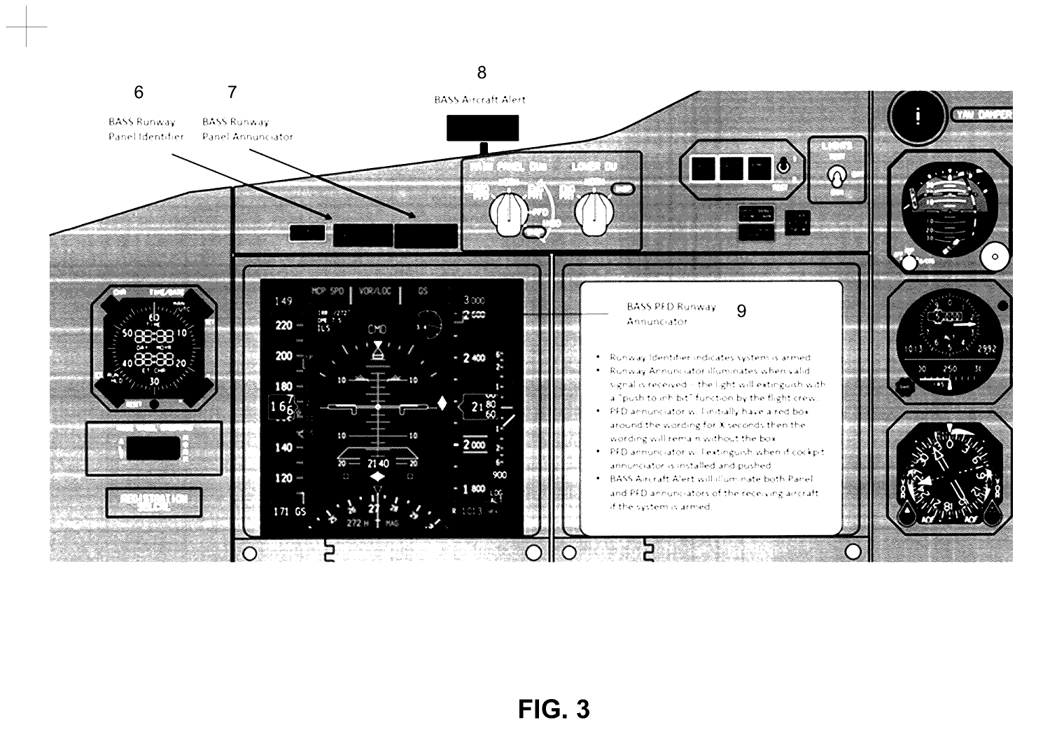

FIG. 3 provides additional details regarding methods of using a computer to take the information from the FMC, course selector, and navigation radios, and providing verification and assurance that both crewmembers are intent on using the same method for navigating to a particular runway. As shown in FIG. 3, embodiments may include displaying this verification to the crew through the use of symbology displayed in the same area as the primary flight displays, primary navigation displays (PND) or anywhere in the primary field of view used by the crew for similar actions. For instance, when a ground based radio system is being used to navigate, a display could show the four letter identifier for that instrument landing frequency such as “IUPX.” If, however a spaced based navigation method is used a similar display could show “RNVY22L” to verify that both crewmembers are using the same spaced based guidance. In most cases, wither the approach is being conducted to a runway using either ground based or space based navigation, the FMC will have the ability to select a specific approach into the active flight path of the aircraft. This may occur with or without what is known as a “route discontinuity.” A runway identifier may be displayed in Item (6), and a braking condition alert corresponding to the identified runway displayed in Item (7). A braking alert generated by the aircraft itself may be displayed, for example, in Item (8). Accordingly, in some embodiments, braking alerts that are generated based on external signals, such as those received from other aircraft or control stations, may prompt one or more visual indicators in one area, whereas braking alerts that are generated based on an aircraft's own monitoring systems, such as those generated by the aircraft's braking monitoring subsystem, may prompt one or more visual indicators in another area. This may be advantageous, for example, in improving a pilot's recognition and reaction to conditions that are anticipated versus those that the aircraft is currently experiencing, tailoring the location of the specific visual indicator to correspond with the pilot's point of view during approach, landing and/or takeoff, tailoring the type and/or configuration of the displays to provide the appropriate amount/type of information, etc.

As also shown in FIG. 3, a runway annunciator may be displayed in Item (9) including, for example, an indication that a braking condition alerting display or other system is activated, an indication that a valid signal is or has been received, etc. In some examples, the display may also be configured to allow the pilots to override or inhibit any of the displayed indicators.

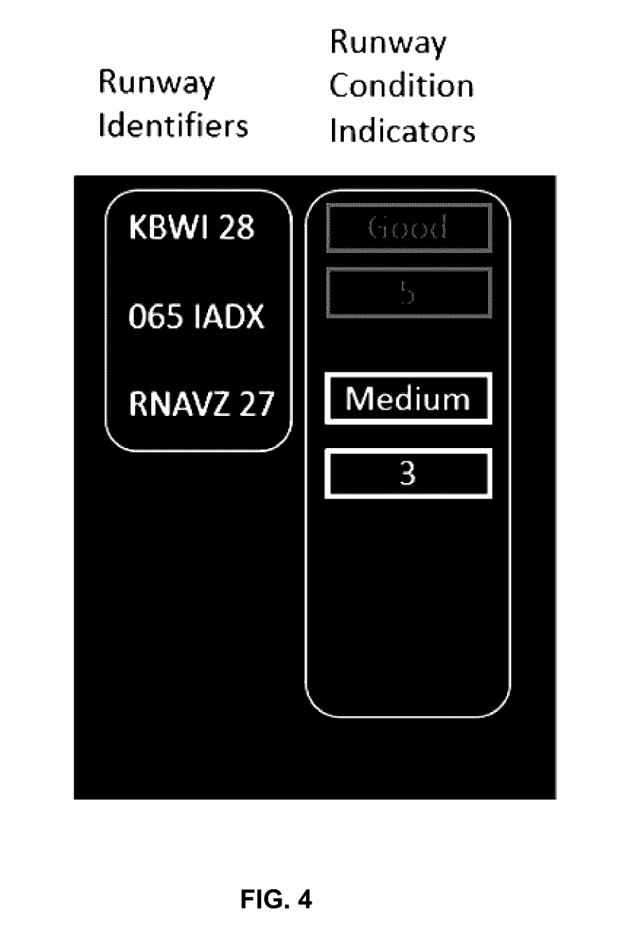

Various manifestation of runway indicators that may be used in conjunction with the systems described herein are shown in FIG. 4, including various runway identifiers, and runway condition indicators that may be determined based on braking conditions, observed runway conditions, and combinations thereof.

In embodiments, the FMC may also have the ability to input a selected runway without reference to a navigational approach. In this case the runway may be displayed as “22L.” The FMC would associate the runway to the particular airport by referencing the airport loaded as the destination in the navigation route. A runway listed without an associated approach may occur when a visual approach is desired and or a ground based navigational reference does not exist for that particular runway. In either case, the system will use the runway selected from the FMC if there is no ground based radio identification present for the runway being used. In another method the display could show an ICAO identifier for the airport in combination with a runway such as “KIRR 27R.” Such an indication would mean that regardless of the navigation method used, the runway 27R at airport KIRR is the intended landing runway.

Of special note is the ability of the system to make reasonable assessments of an aircrew's intentions. Hazards created by false positive signals are a major concern in human integration issues relating to cockpit design and function. For this reason, the function of a PFD to filter ILS radio and navigation settings may be configured to display only when both crewmembers have the same radio and cockpit inputs.

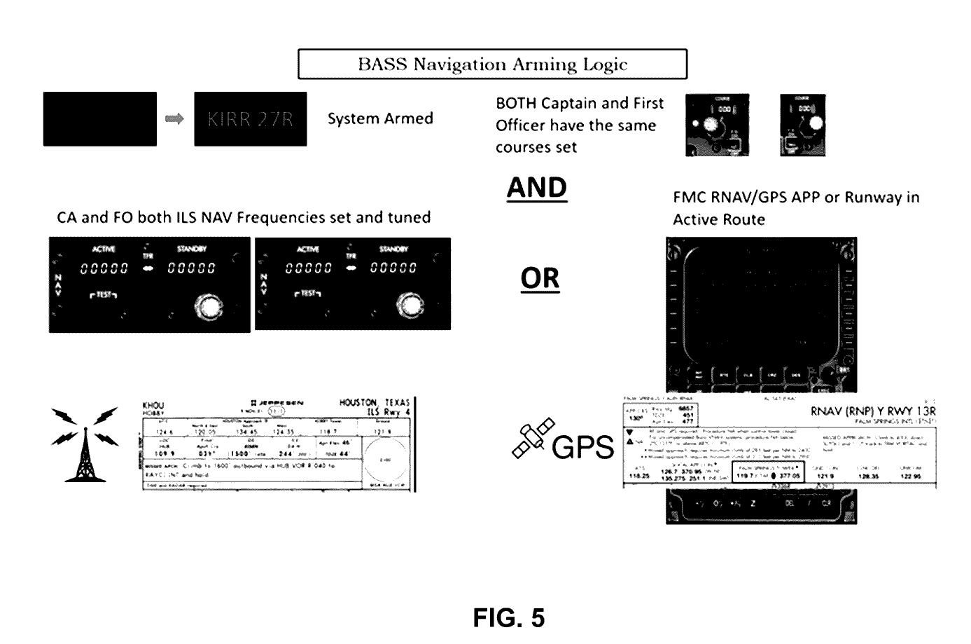

The signal processing logic in FIG. 5 would be able to discriminate between spaced based approaches (GPS/RNAV/RNP), ground based approaches (ILS/VOR), or basic runway identification by discriminating and prioritizing between signal packets contained within the Runway Conditions Signal Packet. For instance, a packet containing an ILS identifier to one runway but an active space-based approach to another runway would code the signal for the space based approach as this would be considered the default guidance for the flight crew.

If both captain and first officer have the same ILS frequency tuned, the same course set, and the ILS radio Morse code signal as identified for a runway that corresponds to both the frequencies and courses set, then it can be reasonably assured that both crewmembers have an intent to land or takeoff from that specific runway. Additionally, if a runway with or without an approach has been loaded into the active route of the FMC, it can be reasonably assumed that both crewmembers are in agreement that runway will be the intended one for use in takeoff or landing.

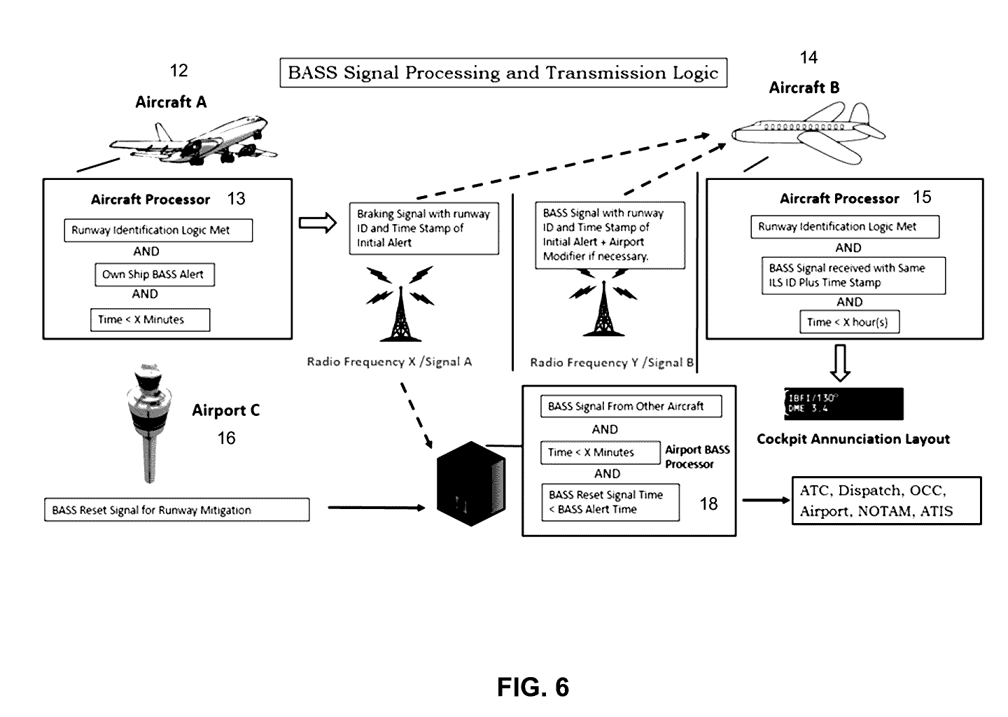

A separate aircraft with this same or similar capability for runway identification would then land and rollout on a runway. Should that aircraft sense a wheel brake condition of a pre-determined value such as but not limited to “Poor” or FAA RCAM Runway Condition Code 1, that aircraft may then automatically or manually through pilot action transmit a signal to relay that information through an electronic means. FIG. 6 shows this as “signal A.” This means could include but would not be limited to such currently employed systems such as ACARS or ADS-B. As shown in FIG. 5 this signal (signal A) would be transmitted on a specific and unique frequency “X” and received by a ground based system comprising a radio receiver, computer, air traffic control (ATC) interface, and transmitter.

For the purposes of this description the following terminology will be used as a non-exclusive manner. The aircraft that has experienced a braking condition first will be known as Aircraft A. The condition being transmitted will be referred to as a “Braking Signal.” This is a non-exclusive term and can mean any signal indicating an aircraft braking condition that would reasonably be desired to achieve the immediate awareness of another flight crew. The second aircraft desiring to obtain this information will be known as Aircraft B. The airport being operated on will be referred to as Airport C. The computer used for processing the information on an aircraft will be known as an “Aircraft Processor.” The computer processing the information from the airport will be referred to as the “Airport Processor.” The human machine interface for the flight crew will be known as the Annunciation Layout and will consist of two elements, a Runway Identifier and a Runway Condition Annunciator. The human interface used by the airport operator will be referred to as the “Braking Signal Tower Interface.”

The braking signal transmitted from aircraft A will be known as “Signal A” and the braking signal coming from the airport will be known as “Signal B.” There are two discreet radio frequencies, the frequency transmitted by the aircraft will be known as “Frequency X” and the frequency transmitted by the airport will be “Frequency Y.” The aircraft processor will be able to receive both frequencies X and Y while the airport processor will only receive frequency X. The non-exclusive system that measures aircraft braking performance will be referred to as the “Aircraft Braking Performance Measuring System.”

Returning to FIG. 6, various means of communicating braking condition and related runway information are provided. This can include, for example, the previously described Signal A that may be transmitted from an aircraft (e.g. Aircraft A (12)) using a specified runway to another aircraft (e.g. Aircraft B (14)) or to a ground control station, such as Airport C (16) and/or Airport BASS Processor (18). Aircraft A (12) may include a processor (13) configured to perform the various functions described herein, and Aircraft B (14) may include a similar processor (15). The Airport BASS processor (18) may include similar functionality as it relates to processing and/or forwarding BASS signals, and providing updated information based on, for example, runway maintenance and the like.

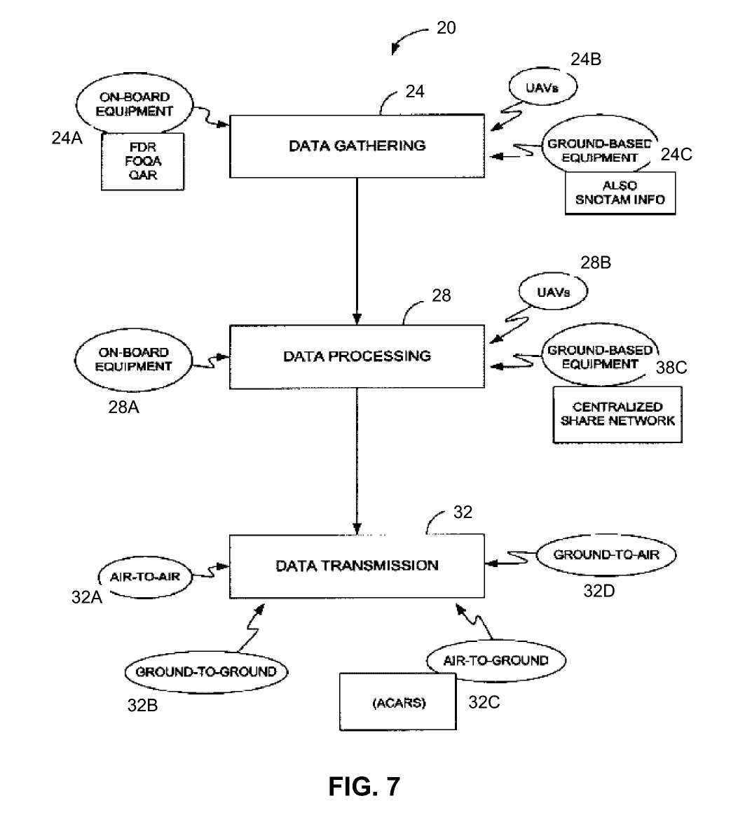

Illustrated in FIG. 7 are optional aspects of a braking condition communication system 20. Typically to be effected by system 20 are actions including gathering (block 24), processing (block 28), and transmitting (block 32) data relating directly or indirectly to, for example, runway conditions and aircraft braking. As noted in preceding sections of this application, activities such as those identified in FIG. 7 may be accomplished using either air- or ground-based equipment (or both).

Data gathering (24) may occur utilizing any or all of equipment on-board manned aircraft (24A) that recently landed at or departed an airport, equipment on-board unmanned aircraft such as UAVs (24B), and ground-based observations (24C). Alternatively or additionally, information may be obtained from Field Condition Reports (FICON) or Snow Warning to Airmen (SNOTAM/SNOWTAM) reports providing airfield conditions such as time of last runway plowing, depth of snow or slush, whether de-icing equipment is in use, etc.

As with gathering of data, processing of data (28) may occur on-board manned aircraft (28A), on-board unmanned aircraft (28B), or using ground-based computing equipment (38C). Combinations of these processor options may be utilized as well. Centralizing data processing may be advantageous at certain airports, or in certain situations, while decentralized processing may be beneficial at other locations or times.

Data transmission (32) preferably occurs automatically to any needed locales. Pilots of to-be-landed aircraft, for example, may receive data directly from other airborne equipment (32A) or via ground-to-air transmissions (32D). As another example, pilots of aircraft scheduled for take-off may receive data from ground-based transmitters (32B) or airborne ones (32C).

In some versions of system 20, processed data may be forwarded to any or all of airlines, airport authorities, the FAA, and air traffic control (ATC) and to pilots via ACARS, SATCOM, DATALINK, or otherwise. The result is a system that may supply automated pilot reports containing objective, data-based information that, particularly (although not necessarily) when coupled with aircraft flight manuals and performance manuals, furnishes pilots with higher-quality assessments of conditions to be expected upon, especially, landing at a particular location.

The transmission of a Braking Signal from one aircraft to another poses unique and substantial human factors and industry challenges. A Braking Signal will prevent most aircraft from continuing to land, thus adding an operational and financial burden to airports and operators. Thus, issue of timeliness, intent, performance assessment, and changing conditions must all be taken into account.

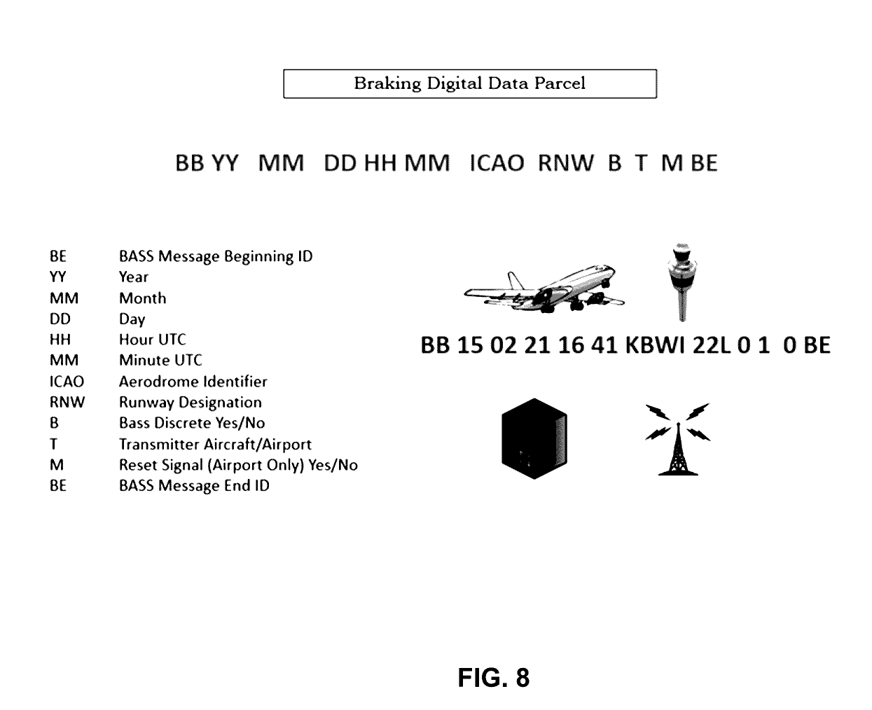

As shown in FIG. 8, the digital information packet used to communicate from aircraft to aircraft, aircraft to ground, and ground to aircraft may comprise of a series of coded signals that may include but may not be limited to the following discrete signal components:
1. Message type and beginning ID
2. Year
3. Month
4. Day
5. Hour
6. Minute
7. Aerodrome Identifier
8. Runway Designation
9. BASS or Other signal discrete relating to runway condition
10. Transmitting Unit (Aircraft/Airport)
11. Re-set Signal
12. Message type and end ID

Returning to FIG. 6, there may be two or more types of processors involved, one ground based processor (18) at the airport itself and other processors (13, 15) onboard various aircraft, in this case labeled aircraft A and B. The ground based processor (18) would have two primary functions. First, it would take the signal from aircraft A (Signal A) on frequency X and repeat the signal on a continuous basis, in this case re-broadcasting it as signal B on frequency Y. Additionally, there will also contain a function whereby an airport operator can take the signal from aircraft A and modify the information. This could occur if the condition reported by signal A has been rendered untrue should a modification to the runway surface occur after signal A was first transmitted by the aircraft.

In the instance, aircraft A would experience a braking condition worthy of reporting. The signal would be encoded and transmitted in a manner so that it could be received by an airport processor (18) and/or aircraft B (14)/processor (15). Both the airport processor and aircraft B would then process the signal and produce an output. In the case of the airport ground unit that processing function could include a modification of the signal. In the case of aircraft B, the processing function could include a decision to deliver a flight deck annunciation and or alert. The decision logic can be seen in FIGS. 9 and 10. In the case where aircraft A had sent a signal A indicating poor braking, aircraft B would process the signal packet and display an annunciation that information to the cockpit. If signal A was modified by the airport, aircraft B would not display any annunciation to the cockpit. The purpose of each processor would be to transmit and receive unique braking signal packets though various means of radio communication (ACARS, ADS-B, SATCOM, UHF, Etc.)

Aircraft would be able to receive signals from either one or two sources, these would be airport based ground transmissions and aircraft transmissions. Ground based transmissions may provide a continuous broadcast of crew alerting information regardless of whether the condition or presence of the previously reporting aircraft. Aircraft transmissions may provide a single transmitted signal to ensure timely alerting for other flight crews and to prevent radio interference with other aircraft. The discrimination and filtering of these signals would take place on the aircraft's receiving and processing computer as shown in FIGS. 9 and 10.

These signal packets could then be processed so that the resultant signal would flow through a discrimination process that would modify the output for conditions that would render a Runway Condition Annunciation invalid. Such discriminators could include but would not be limited to:
Time elapsed—signal duration. No BASS notifications for events that took place 24 hours ago for instance.
Time elapsed—signal generation. If an aircraft had an own-ship BASS alert, it would need to stop transmitting that fact in a reasonable manner prior to the next flight.
Runway discrimination—No alerts for Runway 23L if landing on Runway 23R
Crew Intent—No nuisance alerts for a crew that is not planning to land on that particular runway.
Airport Mitigations—No false alerts for a signal generated before a runway was plowed or otherwise treated.

The aircraft receiving the signal could be on the ground or in the air. The signal may apply to both takeoff and landing performance assessments. The signal itself may be displayed as a navigational function and could be a PFD/NFD (Navigational Flight Display) annunciation located in the proximity to an approach related symbology as shown in FIGS. 2 and 3. Such an annunciation could also take the form of a monochrome or color HUD symbology. It could also be a separate annunciation located in the field of view of the instrument panel such as a typical warning or caution light as shown in FIG. 3. The information could be presented with several possible display options.

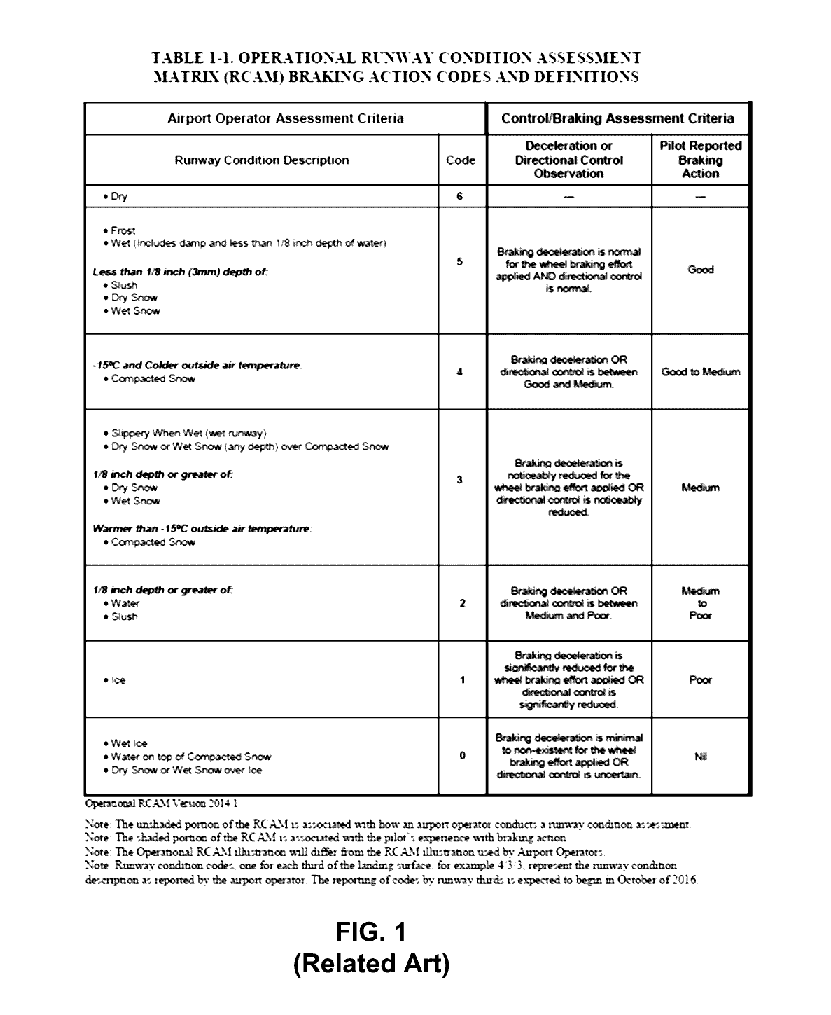

As noted previously, FIG. 4 shows various examples the receiving aircraft could use to provide a crew annunciation. The runway may be identified using references to land based radio identification codes, airport specific codes, or space based navigation or other means to depict a specific runway on a specific airport. The level of performance experienced by the transmitting aircraft could use standard aviation conventions in color coding to represent advisory, cautionary, or alerting information. The numerical designations and textual information could take the form of numbers or words that are associated with the RCAM guidance seen in FIG. 1. In this case it would include but not be limited to the information included in the “code” and “Pilot reported braking action” columns.

In embodiments, two discrete radio frequencies could be used and their respective signal packets would be used as a paired set, one for aircraft transmission, the other for airport transmission. This allows for two important functions to take place. First is that a Braking Signal would be available to other aircraft intending to use the runway if the aircraft generating the initial Braking Signal loses power or is no longer in range to transmit a signal. Secondly the airport must have a means to stop a Braking Signal from being received by other aircraft if they have taken actions on that runway that render the signal obsolete.

Using the methods as described herein may ensure, for example, that an aircraft receiving the alerting signal or information is intending to land on the exact same runway as the aircraft providing the alerting signal or information, and/or the signal being shared between the two aircraft is in fact a valid indication of what the degree of wheel brake performance that can be expected for that particular runway.

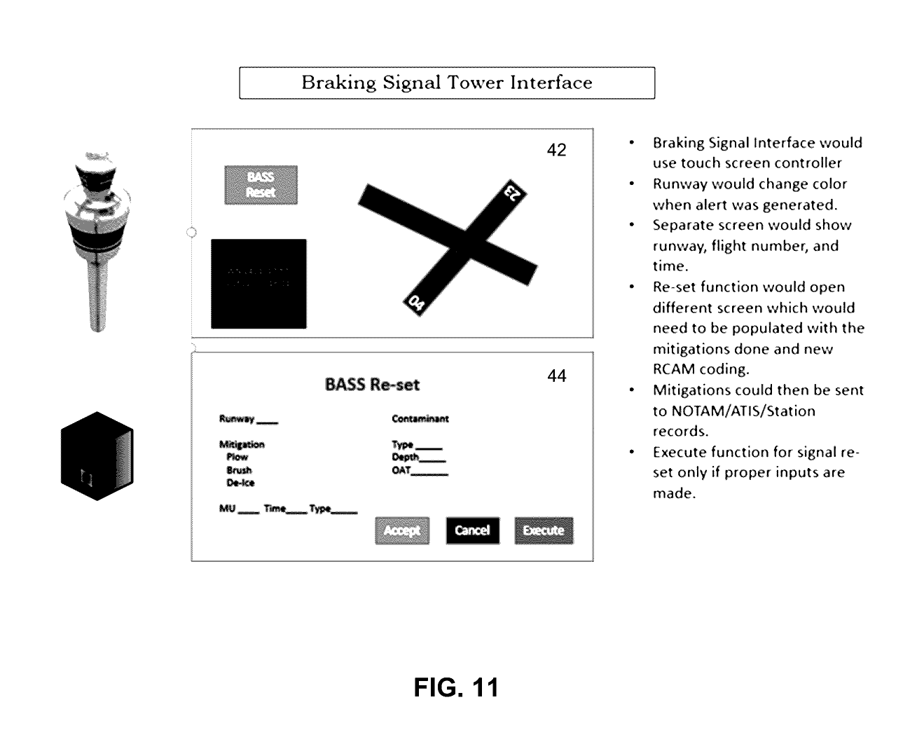

FIG. 11 shows aspects of a method whereby an airport operator would be able to visually identify a runway that has been identified though the described methods as being associated with a runway condition alert. For example, FIG. 11 shows a display (42) configured to visually depict a runway with an associated braking condition alert in a different color such as red. Display (42) also includes an area for the airport operator to identify the aircraft type and flight number transiting the report as well as the time the event occurred. Further methods could include but would not be limited to the ability for the airport operator or ATC controller to cancel the alerting signal sent from the ground station to the aircraft. This method could include an input such as shown in display area (44) for describing what actions were taken to facilitate the cancellation of the signal for use in reporting and or recordkeeping. Based on the input received in display area (44), the ground-based control processor may update and/or cancel previous braking condition alerts, such as that shown in area (42), and may initiate a new braking condition signal that is transmitted to one or more aircraft.

In some examples, braking condition alerts as described herein may be displayed, for example, using the field of view associated with primary flight displays to include but not limited to electronic PFD's, Heads Up Displays, or the area within this field of view where these type of displays are normally associated. Such displays may include, for example, flashing amber pixels, flashing red pixels, alternating flashing amber and red pixels, steady illumination of amber pixels, and/or steady illumination of red pixels. Illumination may be provided in any suitable manner, including (but not limited to) light-emitting diodes (LEDs), fiber optics, or other light sources. Intensity of the pixels may be set differently for day and night operations in coordination with a selection signal generated by the operator for the general instrument panel that is common to most aircraft.

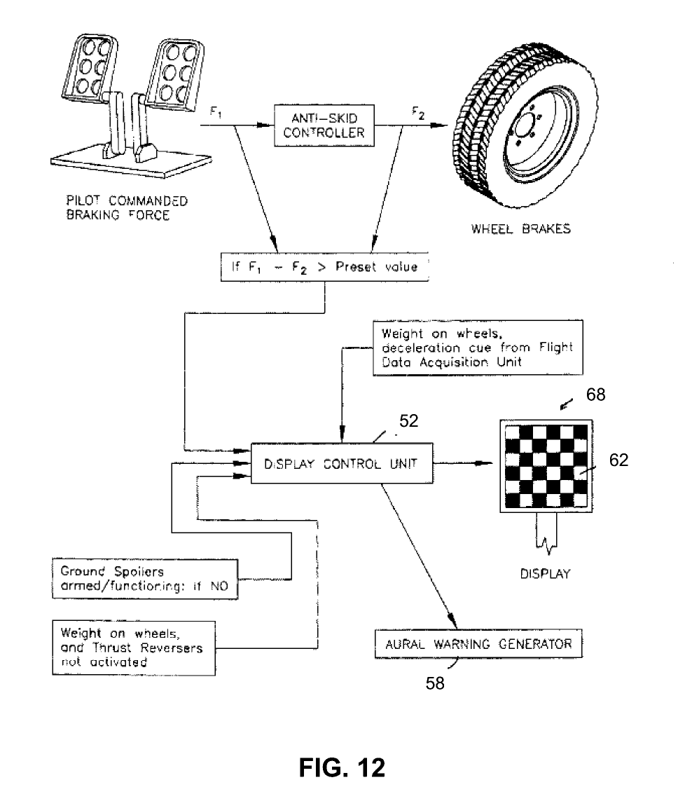

Detailed in FIG. 12 are examples of flow paths of information that may be gathered, generated, obtained, or calculated for a system onboard an aircraft, such as processor (15) in FIG. 6. Consistent with aspects of the Edwards patent, performance of the wheel brake system of aircraft A may be defined by the relationship between the two forces designated F₁ and F₂ with F₁ relating to braking force commanded by the pilot and F₂ relating to braking force delivered following operations of an aircraft anti-skid controller. If the difference between F₁ and F₂ exceeds a preset threshold, for example, a real-time state of degraded braking system performance exists. Existence of degraded system performance in turn suggests alternate techniques may be required by the aircraft operator to mitigate risks such a state represents, causing alert activity via display control unit (52), on display (68) with pixels (62) and on optional aural warning generator (58). Existence of the degraded performance also may be transmitted to operators of other craft or elsewhere in the form of a braking condition signal described herein.

FIG. 12 also depicts other examples of information that could result in alert activity on display (68) or other display described herein, as well as transmission of a braking condition signal. Any or all of the information may be input to control unit (52) (which may be integral with or separate from processors described herein) for assessment together with information confirming that the aircraft has achieved weight on wheels (WOW) since having become airborne or is in the process of decelerating once acceleration has occurred (such as with a rejected takeoff, for example). This information may arrive via a data stream utilizing the flight data acquisition unit of the aircraft as used to deliver information to the flight data recorder and or quick access recorder if the aircraft is so equipped.

Control unit (52) also may accept input from vehicle operators, cockpit equipment, or otherwise. As an example, at times an aircraft may be considered airworthy notwithstanding inoperative thrust reversers or autobrakes. This inoperability thus may be identified to control unit (52), so no monitoring of the known inoperative equipment need occur.

Various embodiments of an alerting device may include a display unit, e.g. (68), with a visual indicator comprising multiple pixels (62). The device also may include a mounting post and a glare shield if desired or appropriate. Individual pixels, or contiguous sets of pixels, preferably are colored red and amber alternately, although other colors may be employed instead. Red and amber are preferred colors at least in part because they are used in human-factors designs of cockpits, with amber representing a cautionary alert and red representing an emergency. Alternatively or additionally, the indicator may define letters, words, or symbols or flash colors alternately on different portions of the device. The configuration may be a separate indicator, incorporated as an alert displayed on a heads-up navigation device, or mounted to a windshield pillar, for example. Light intensities may vary for day or night conditions, for example, or otherwise as suitable. Similarly, flashing frequencies may vary. Information conveyed by the device to a vehicle operator may assist the operator in mitigating hazards.

Braking effectiveness information may include, but need not be limited to, information concerning aircraft type, weight, and center of gravity, aircraft speed as a function of time, when braking commenced relative to aircraft touch down, where braking commenced relative to a given runway position, and when and where reverse thrust or certain flaps or spoilers were deployed. Other information potentially useful to obtain may include time and place of touch down, aircraft weight, standard landing gear configuration, brake application speed, type of braking-ABS setting, anti-skid operations (to include brake pressure commanded by the pilot's brake pedals and the pressure delivered to the braked after anti-skid control computer calculations), aircraft stopping point, flap/slat settings, landing gear configuration, and first nose wheel tiller movement past normal nose wheel displacement during landing to indicate termination of landing ground roll and commencement of the taxi phase. Further possibly-useful information may include deceleration rates gathered from Inertial Navigation Unit (INU) decelerometers as well as the time and distance of the deceleration to assist in ground roll distance computations. Yet additional information potentially useful to obtain is whether any equipment of the aircraft is placarded inoperative or degraded per the minimum equipment listing (MEL), whether anti- or de-icing systems were in use, and weather-related information including (but not limited to) winds aloft (speed and direction), windshear detection, temperature, etc. If not measured or obtained on-board an aircraft (by, as a non-limiting example, the aircraft anti-skid controller), some or all of the information may be measured by ground-based (or other) equipment. Any such measurements also may be utilized to verify information measured on-board the aircraft.

Dissemination of processed data may occur via ACARS (the Aircrew Communication Addressing and Reporting System, ATIS (the Automatic Terminal Information Service), ADSB, or other ground-to-cockpit communications channels. The data additionally preferably may be available to participants in airfield and airline operations, air traffic controllers, and flight crews, with copies stored for historical purposes or analysis. If appropriate, the data should be afforded protections normally provided safety information. The data further may be supplemented with ground-based information such as depth of contamination, current weather conditions, precipitation intensity, time of last runway plowing, location of last runway plowing in relation to distance from runway centerline, and salting/chemical treatment of runway. At least some of this supplemental information soon may be available in automated reports using technologies of airport communications integrators.

The foregoing systems and methods can include and/or be embodied in computer instructions provided in data stores and other memory and storage media as known in the art. These can reside in a variety of locations, such as on a storage medium local to (and/or resident in) one or more of the computers onboard an aircraft and/or remote from any or all of the computers across a local or wide-area network. Any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (“CPU”), at least one input device (e.g., a mouse, keyboard, controller, touch screen or keypad) and at least one output device (e.g., a display device, printer or speaker). Such a system may also include one or more storage devices, such as disk drives, optical storage devices and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired), an infrared communication device, etc.) and working memory as described above. The computer-readable storage media reader can be connected with, or configured to receive, a computer-readable storage medium, representing remote, local, fixed and/or removable storage devices as well as storage media for temporarily and/or more permanently containing, storing, transmitting and retrieving computer-readable information. The system and various devices also typically will include a number of software applications, modules, services or other elements located within at least one working memory device, including an operating system and application programs, such as a client application. It should be appreciated that alternate embodiments may have numerous variations from that described above. For example, customized hardware might also be used and/or particular elements might be implemented in hardware, software (including portable software, such as applets) or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules or other data, including RAM, ROM, Electrically Erasable Programmable Read-Only Memory (“EEPROM”), flash memory or other memory technology, Compact Disc Read-Only Memory (“CD-ROM”), digital versatile disk (DVD) or other optical storage, magnetic cassettes, magnetic tape, magnetic disk storage or other magnetic storage devices or any other medium which can be used to store the desired information and which can be accessed by the a system device. Based on the disclosure and teachings provided herein, a person of ordinary skill in the art will appreciate other ways and/or methods to implement the various embodiments.

Changes and modifications, additions and deletions may be made to the structures and methods recited above and shown in the drawings without departing from the scope or spirit of the disclosure or the following claims.

What is claimed is:

1. An aircraft braking condition communications and braking condition signal alert system for use in an aircraft, the system comprising:
a receiver configured to receive a first braking condition signal from at least one of another aircraft or a control station, the first braking condition signal including first braking condition information for a specified runway;
a braking subsystem configured to monitor braking conditions of the aircraft and to generate second braking condition information based on a comparison of the braking conditions and a predetermined threshold;
a processor configured to analyze the first braking condition information and the second braking condition information, to generate a braking alert signal based on at least one of the first braking condition information and the second braking condition information, and to generate a second braking condition signal based at least in part on the second braking condition information;
an alert display configured to receive the braking alert signal, and to present a visual indicator to an operator of the aircraft based on the braking alert signal;
a transmitter configured to transmit the second braking condition signal to at least one of another aircraft and or the control station,
wherein the processor is further configured to overwrite the first braking condition information based on a third braking condition signal received from at least one of another aircraft or the control station.

2. The system of claim 1, wherein the first braking condition signal includes a runway identifier, and the processor is further configured to generate the braking alert signal based at least in part on the runway identifier.

3. The system of claim 1, further comprising a navigation subsystem configured to identify an intended runway to be used for at least one of takeoff or landing,
wherein the first braking condition signal includes a runway identifier, and the processor is further configured to generate the braking alert signal based at least in part on a determination that the runway identifier corresponds to the intended runway.

4. The system of claim 1, wherein the first braking condition signal is received from an aircraft, and the third braking condition signal is received from a control station.

5. The system of claim 1, wherein the first braking condition signal is received from an aircraft, and the third braking condition signal is received from another aircraft.

6. The system of claim 1, wherein the first braking condition signal is received from a control station, and the third braking condition signal is received from an aircraft.

7. The system of claim 1, wherein the braking signals and alerts correspond to predetermined thresholds that are associated with standardized runway-related aircraft performance codes included in a regulatory publication.

8. The system of claim 1, wherein the braking condition signals share a common format including a timestamp, an airfield identifier, a runway identifier, and a braking condition identifier.

9. The system of claim 1, wherein the braking condition signals include, or are based on, a combination of airport operator runway assessment information and aircraft braking condition information.

10. A system for providing aircraft braking condition communication and braking condition signal alerts comprising:
a receiver configured to receive a first braking condition signal from a first aircraft, the first braking condition signal including first braking condition information for a specified runway;
a processor configured to analyze the first braking condition information, and to generate a braking condition signal based at least in part on the first braking condition information;
a transmitter configured to send the braking condition signal to a second aircraft;
wherein the processor is further configured to overwrite the first braking condition information based on at least one of a second braking condition signal received from another aircraft for the specified runway, or a runway condition update for the specified runway, and
the transmitter is further configured to send an updated braking condition signal to the second aircraft based at least in part on the processor overwriting the first braking condition information.

11. The system of claim 10, wherein the processor is further configured to generate a braking alert signal based on the first braking condition information, and to cause display of a visual indicator based on the braking alert signal, the visual indicator presented to an airport operator that is intending the specified runway to be used for at least one of takeoff or landing.

12. The system of claim 10, wherein the first braking condition signal includes a runway identifier, and the processor is further configured to generate the braking condition signal for other aircraft that are intending to use the specified runway for at least one of takeoff or landing.

13. The system of claim 10, wherein the predetermined thresholds for the braking conditions signals and alerts are associated with standardized runway-related aircraft performance codes included in a regulatory publication.

14. The system of claim 10, wherein the braking condition signals share a common format including a timestamp, an airfield identifier, a runway identifier, and a braking condition identifier.

15. The system of claim 10, wherein the updated braking condition signal is sent in preparation to, or during, at least one of takeoff or landing of the second aircraft.

16. A method for providing aircraft braking signal alerts for aircraft comprising:
receiving a first braking condition signal from at least one of a first aircraft or a control station, the first braking condition signal including a timestamp, an airfield identifier, a runway identifier, and first braking condition information;
determining a runway to be used by a second aircraft for at least one of takeoff or landing;
analyzing the first braking condition signal and determining that the first braking condition information is relevant to the second aircraft based on the airfield identifier, the runway identifier and the runway to be used by the second aircraft;
generating a braking alert signal for the second aircraft based at least in part on the first braking condition information;
presenting a visual indicator to an operator of the second aircraft based at least in part on the braking alert signal; and
overwriting the first braking condition information based on a second braking condition signal received from at least one of a third aircraft or the control station.

17. The method of claim 16, further comprising monitoring braking conditions of the second aircraft during the at least one of takeoff or landing, and generating a third braking condition signal for the runway via the second aircraft based on a comparison of the braking conditions and predetermined thresholds.

18. The method of claim 17, wherein the predetermined thresholds are associated with standardized runway-related aircraft performance codes included in a regulatory publication.

19. The method of claim 16, wherein the first braking condition signal is received from an aircraft, and the second braking condition signal is received from a control station.

20. The method of claim 16, wherein the braking condition signals include, or are based on, a combination of airport operator runway assessment information and aircraft braking condition information.

21. The method of claim 16, wherein determining the runway to be used by the second aircraft includes analyzing navigation information from at least two different operators of the second aircraft.

22. The method of claim 16, wherein determining the runway used by the first aircraft includes analyzing navigation information from at least two different operators of the first aircraft.
